(19) United States
(12) Patent Application Publication
(10) Pub. No.: US 2024/0278702 A1
(43) Pub. Date: Aug. 22, 2024

(54) Vehicle Pedal Footwear Protection Device

(71) Applicant: Evelin Ibarra, Las Vegas, NV (US)

(72) Inventor: Evelin Ibarra, Las Vegas, NV (US)

(21) Appl. No.: 18/435,410

(22) Filed: Feb. 7, 2024

Related U.S. Application Data
(60) Provisional application No. 63/446,503, filed on Feb. 17, 2023.

(51) Int. Cl. B60N 3/04

(52) U.S. Cl. CPC B60N 3/044

(57) ABSTRACT

A vehicle pedal footwear protection device is provided. The device is comprised of a body that can be attached to the floor of a vehicle via at least one fastener. The body is preferably positioned in front of and/or under the pedals of a vehicle such that a user can rest/position their foot on a top surface of the body while driving. The top surface is made from a soft material that does not scuff or damage the footwear of a user.

### CROSS-REFERENCE TO RELATED APPLICATION

The present application claims priority to, and the benefit of, U.S. Provisional Application No. 63/446,503, which was filed on Feb. 17, 2023, and is incorporated herein by reference in its entirety.

### FIELD OF THE INVENTION

The present invention relates generally to the field of footwear protection devices. More specifically, the present invention relates to a vehicle pedal footwear protection device that is comprised of a body that can be secured to a vehicle floor in front of the pedals of the vehicle. The top surface of the body is comprised of a soft material that does not damage the shoes of a user. Accordingly, the present disclosure makes specific reference thereto. Nonetheless, it is to be appreciated that aspects of the present invention are also equally applicable to other like applications, devices, and methods of manufacture.

### BACKGROUND

When driving, the heel area of a driver's footwear often undergoes a considerable amount of friction as it scrapes back and forth against the vehicle's floor while operating the pedals of a vehicle. This repeated action, especially prevalent during long drives or frequent commuting, can lead to noticeable wear and tear on the footwear. Individuals who wear high heels or professional dress footwear are particularly susceptible to this issue. These types of footwear, often made from delicate materials and featuring intricate designs can easily accumulate stains and scuffs on their heels. This not only detracts from their aesthetic appeal but also potentially damages the footwear's structural integrity.

The constant contact with the vehicle floor, which might be laden with dirt, dust, or other abrasive substances, further exacerbates this problem. Without any form of protection or preventative measure, these footwear may quickly look unsightly, losing their luster and neat appearance. As a result, owners of such footwear might find themselves faced with the need for significant cleaning and maintenance efforts to restore their footwear to a presentable condition. In some cases, the damage might be severe enough to require professional repair services, which can be both costly and time-consuming.

Therefore, there exists a long-felt need in the art for a device that can be used to protect footwear from damage while driving. There also exists a long-felt need in the art for a vehicle pedal footwear protection device. More specifically, there exists a long-felt need in the art for a vehicle pedal footwear protection device that protects footwear from wear and damage from contacting the floor of a vehicle while operating the pedals of the vehicle.

The subject matter disclosed and claimed herein, in one embodiment thereof, comprises a vehicle pedal footwear protection device. The device is comprised of a body that can be attached to the floor of a vehicle via at least one fastener. The body is preferably positioned in front of and/or under the pedals of a vehicle such that a user can rest/position their foot on a top surface of the body while driving. The top surface is made from a soft material that does not scuff or damage the footwear of a user.

In this manner, the vehicle pedal footwear protection device of the present invention accomplishes all the foregoing objectives and provides a device that can be used to protect footwear from damage while driving. More specifically, the device protects footwear from wear and damage from contacting the floor of a vehicle while operating the pedals of the vehicle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle pedal footwear protection device comprised of a body that can be secured to a vehicle floor in front of at least one pedal of the vehicle. The body is comprised of a top surface made of a soft material that does not damage the footwear of the user while operating the pedals.

The body may be any that allows the body to cover the area of a vehicle floor in front of (and/or underneath) the pedals of the vehicle. The bottom surface of the body is comprised of at least one fastener. In another embodiment, the fastener attaches to at least one secondary fastener of the device. The secondary fastener is comprised of a top surface and a bottom surface that may be any fastener surface. In this manner, the fasteners allow the body to be securely secured in position on a vehicle floor.

The top surface of the body is preferably comprised of a soft material. Said material preferably does not scuff (or otherwise dirty/damage) the footwear of the user when a user rests any part of their footwear on the top surface. As a result, no scuffs or damage occurs when a user's footwear rests on and/or contacts the top surface during use. In one embodiment, the surface also has a waterproof coating to prevent water damage.

The present invention is also comprised of a method of using the device. First, a device is provided comprised of a body comprised of a top surface and a bottom surface comprised of at least one fastener. Then, the fastener can be attached to a vehicle floor in a position in front of at least one pedal of the vehicle (i.e., between the pedal and the user) and/or underneath at least one pedal. Finally, a user can rest/place their foot (while wearing footwear) on the top surface of the body while using the pedals to drive.

The present invention is also comprised of a second method of using the device. First, a device is provided comprised of a body comprised of a top surface and a bottom surface comprised of at least one fastener, and a fastener comprised of a top surface and a bottom surface. Then, a bottom surface of the fastener can be attached to a vehicle floor in a position in front of at least one pedal of the vehicle (i.e., between the pedal and the user) and/or underneath at least one pedal. Next, a user can attach the top surface of the fastener to the fastener of the bottom surface of the body. Finally, a user can rest/place their foot (while wearing footwear) on the top surface of the body while using the pedals to drive.

Accordingly, the vehicle pedal footwear protection device of the present invention is particularly advantageous as it provides a device that can be used to protect footwear from damage while driving. More specifically, the device protects footwear from wear and damage from contacting the floor of a vehicle while operating the pedals of the vehicle. In this manner, the vehicle pedal footwear protection device provides a solution to prevent footwear wear and tear incurred while operating the pedals of a vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a top surface of one potential embodiment of a vehicle pedal footwear protection device of the present invention in accordance with the disclosed architecture;

FIG. 2 illustrates a perspective view of a bottom surface of one potential embodiment of a vehicle pedal footwear protection device of the present invention in accordance with the disclosed architecture;

FIG. 3 illustrates a perspective view of a fastener of one potential embodiment of a vehicle pedal footwear protection device of the present invention while attached to a vehicle floor in accordance with the disclosed architecture;

FIG. 4 illustrates a perspective view of one potential embodiment of a vehicle pedal footwear protection device of the present invention while attached to a vehicle floor in accordance with the disclosed architecture;

FIG. 5 illustrates a flowchart of a method of using one potential embodiment of a vehicle pedal footwear protection device of the present invention in accordance with the disclosed architecture; and

FIG. 6 illustrates a flowchart of a method of using one potential embodiment of a vehicle pedal footwear protection device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to protect footwear from damage while driving. There also exists a long-felt need in the art for a vehicle pedal footwear protection device. More specifically, there exists a long-felt need in the art for a vehicle pedal footwear protection device that protects footwear from wear and damage from contacting a floor of a vehicle while operating the pedals of the vehicle.

The present invention, in one exemplary embodiment, is comprised of a vehicle pedal footwear protection device. The device is comprised of a body that can be secured to a vehicle floor in front of at least one pedal of the vehicle. The body is comprised of a top surface. The top surface is made of a soft material that does not damage the footwear of the user while operating the pedals.

The body may be any that allows the body to cover the area of a vehicle floor in front of (and/or underneath) the pedals of the vehicle. The bottom surface of the body is comprised of at least one fastener. In another embodiment, the fastener attaches to at least one secondary fastener of the device. The secondary fastener is comprised of a top surface and a bottom surface that may be any fastener surface. In this manner, the fasteners allow the body to be securely secured in position on a vehicle floor.

The top surface of the body is preferably comprised of a soft material that preferably does not scuff (or otherwise dirty/damage) the footwear of the user when a user rests any part of their footwear on the top surface. As a result, no scuffs or damage occurs when a user's footwear rests on and/or contacts the top surface during use. In one embodiment, the surface also has a waterproof coating to prevent water damage.

The present invention is also comprised of a method of using the device. First, a device is provided comprised of a body comprised of a top surface and a bottom surface comprised of at least one fastener. Then, the fastener can be attached to a vehicle floor in a position in front of at least one pedal of the vehicle (i.e., between the pedal and the user) and/or underneath at least one pedal. Finally, a user can rest/place their foot (while wearing footwear) on the top surface of the body while using the pedals to drive.

The present invention is also comprised of a second method of using the device. First, a device is provided comprised of a body comprised of a top surface and a bottom surface comprised of at least one fastener, and a fastener comprised of a top surface and a bottom surface. Then, a bottom surface of the fastener can be attached to a vehicle floor in a position in front of at least one pedal of the vehicle (i.e., between the pedal and the user) and/or underneath at least one pedal. Next, a user can attach the top surface of the fastener to the fastener of the bottom surface of the body. Finally, a user can rest/place their foot (while wearing footwear) on the top surface of the body while using the pedals to drive.

Accordingly, the vehicle pedal footwear protection device of the present invention is particularly advantageous as it provides a device that can be used to protect footwear from damage while driving. More specifically, the device protects footwear from wear and damage from contacting a floor of a vehicle while operating the pedals of the vehicle. In this manner, the vehicle pedal footwear protection device provides a solution to prevent footwear wear and tear incurred while operating the pedals of a vehicle.

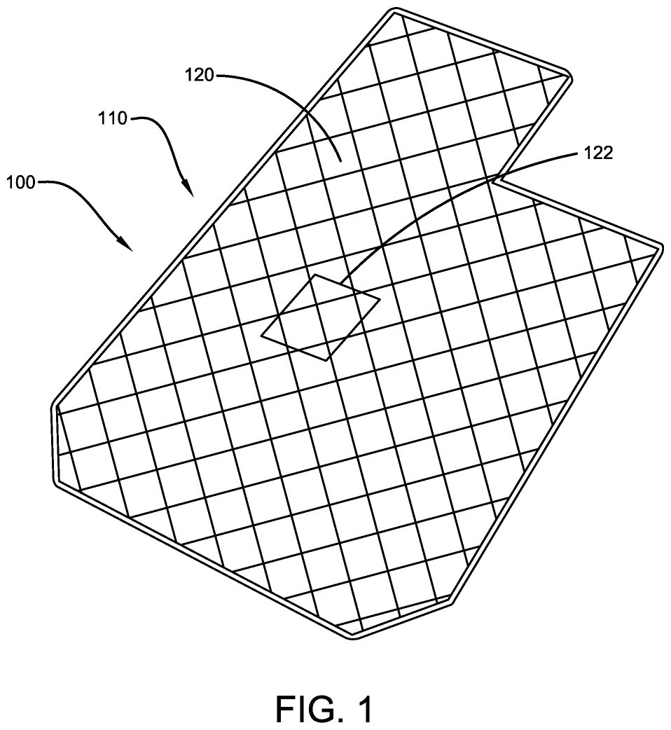

Referring initially to the drawings, FIG. 1 illustrates a perspective view of a top surface of one potential embodiment of a vehicle pedal footwear protection device of the present invention in accordance with the disclosed architecture. The device 100 is comprised of a body 110 that can be secured to a vehicle floor 10 in front of at least one pedal 12 of the vehicle. The body 110 is comprised of a top surface 120 made of a soft material that does not damage the footwear of the user while operating the pedals 12.

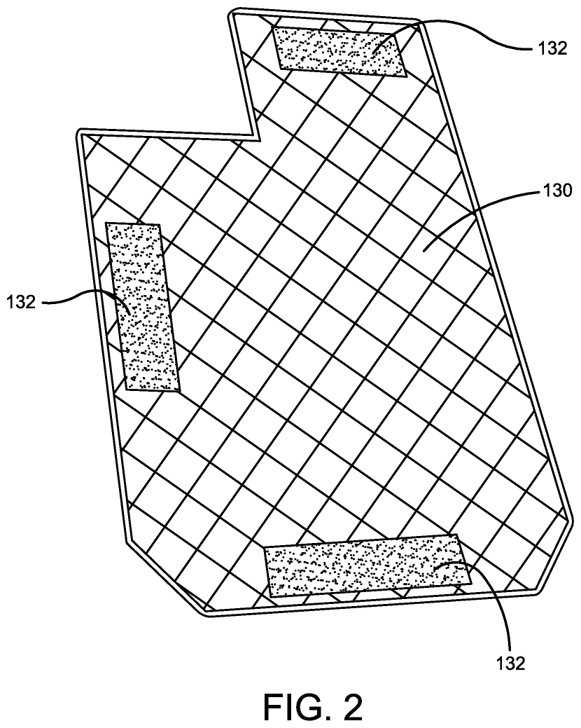

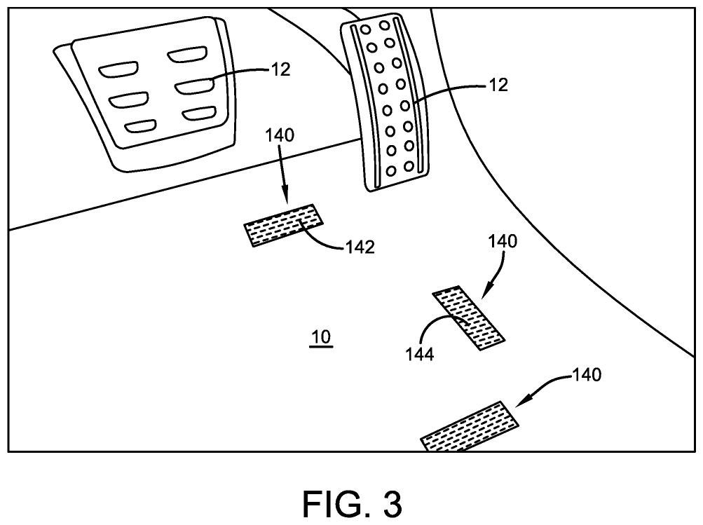

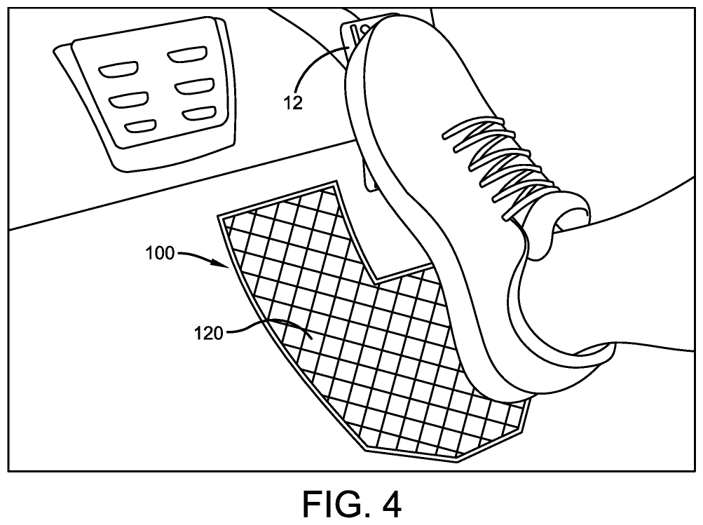

The body 110 may be any shape in different embodiments. This includes any shape that allows the body to cover the area of a vehicle floor 12 in front of (and/or underneath) the pedals 12 of the vehicle. The bottom surface 130 of the body 110 is comprised of at least one fastener 132, as seen in FIG. 2. The fastener 132 may include, but is not limited to, a hook fastener, a loop fastener, an adhesive fastener, a clip fastener, a magnet, etc. The fastener 132 allows the body 110 to attach to a vehicle floor 10. In another embodiment, the fastener 132 attaches to at least one secondary fastener 140 of the device 100. The secondary fastener 140 is comprised of a top surface 142 and a bottom surface 144, as seen in FIG. 3. The surfaces 142, 144 may be any fastener surfaces such as, but not limited to, a hook surface, a loop surface, an adhesive surface, a magnetic surface, etc. In this manner, the fasteners 132, 140 allow the body 110 to be securely secured in position on a vehicle floor 10, as seen in FIG. 4.

The top surface 120 of the body 110 is preferably comprised of a soft material. Said material preferably does not scuff (or otherwise dirty/damage) the footwear of the user when a user rests any part of their footwear on the top surface 120. The top surface 120 material may include, but is not limited to, a microfiber, a neoprene, a felt, a silicone, a leather, a faux leather, a polyurethane foam, a suede, a plastic, a tpe (thermoplastic elastomers), etc. As a result, no scuffs or damage occurs when a user's footwear rests on and/or contacts the top surface 120 during use. In one embodiment, the surface 120 also has a waterproof coating 122 to prevent water damage. In one embodiment, the top surface 120 is comprised of a raised texture and/or a recessed texture to increase grip and prevent a user's footwear from slipping while contacting the top surface 120, as seen in FIG. 4.

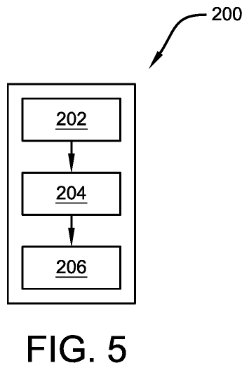

The present invention is also comprised of a method of using 200 the device 100, as seen in FIG. 5. First, a device 100 is provided comprised of a body 110 comprised of a top surface 120 and a bottom surface 130 comprised of at least one fastener 132 [Step 202]. Then, the fastener 132 can be attached to a vehicle floor 10 in a position in front of at least one pedal 12 of the vehicle (i.e., between the pedal 12 and the user) and/or underneath at least one pedal 12 [Step 204]. Finally, a user can rest/place their foot (while wearing footwear) on the top surface 120 of the body 110 while using the pedals 12 to drive [Step 206].

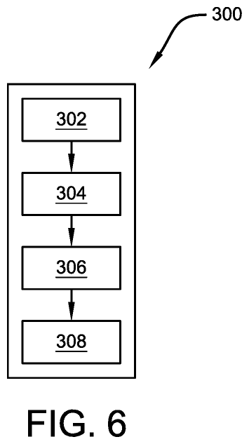

The present invention is also comprised of a second method of using 300 the device 100, as seen in FIG. 6. First, a device 100 is provided comprised of a body 110 comprised of a top surface 120 and a bottom surface 130 comprised of at least one fastener 132, and a fastener 140 comprised of a top surface 142 and a bottom surface 144 [Step 302]. Then, a bottom surface 144 of the fastener 140 can be attached to a vehicle floor 10 in a position in front of at least one pedal 12 of the vehicle (i.e., between the pedal 12 and the user) and/or underneath at least one pedal 12 [Step 304]. Next, a user can attach the top surface 142 of the fastener 140 to the fastener 132 of the bottom surface 130 of the body 110 [Step 306]. Finally, a user can rest/place their foot (while wearing footwear) on the top surface 120 of the body 110 while using the pedals 12 to drive [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle pedal footwear protection device” and “device” are interchangeable and refer to the vehicle pedal footwear protection device 100 of the present invention.

Notwithstanding the foregoing, the vehicle pedal footwear protection device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle pedal footwear protection device 100 as shown in the FIGS. are for illustrative purposes only, and that many other sizes and shapes of the vehicle pedal footwear protection device 100 are well within the scope of the present disclosure. Although the dimensions of the vehicle pedal footwear protection device 100 are important design parameters for user convenience, the vehicle pedal footwear protection device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle pedal footwear protection device comprising:
a body comprised of a top surface and a bottom surface; and
a fastener positioned on the bottom surface.

2. The vehicle pedal footwear protection device of claim 1, wherein the fastener is comprised of a hook fastener, a loop fastener, an adhesive fastener, a clip fastener, or a magnet.

3. The vehicle pedal footwear protection device of claim 1, wherein the top surface is comprised of a microfiber, a neoprene, a felt, a silicone, a leather, a faux leather, a polyurethane foam, a suede, a plastics, or a thermoplastic elastomers.

4. The vehicle pedal footwear protection device of claim 3, wherein the top surface is comprised of a waterproof coating.

5. The vehicle pedal footwear protection device of claim 3, wherein the top surface is comprised of a raised texture.

6. The vehicle pedal footwear protection device of claim 3, wherein the top surface is comprised of a recessed texture.

7. A vehicle pedal footwear protection device comprising:
a body comprised of a first top surface and a first bottom surface; and
a first fastener positioned on the first bottom surface; and
a second fastener comprised of a second top surface and a second bottom surface.

8. The vehicle pedal footwear protection device of claim 7, wherein the first fastener is comprised of a hook fastener, a loop fastener, an adhesive fastener, a clip fastener, or a magnet.

9. The vehicle pedal footwear protection device of claim 7, wherein the second top surface is comprised of a hook surface, a loop surface, an adhesive surface, or a magnetic surface.

10. The vehicle pedal footwear protection device of claim 7, wherein the second bottom surface is comprised of a hook surface, a loop surface, an adhesive surface, or a magnetic surface.

11. The vehicle pedal footwear protection device of claim 7, wherein the first top surface is comprised of a microfiber, a neoprene, a felt, a silicone, a leather, a faux leather, a polyurethane foam, a suede, a plastics, or a thermoplastic elastomers.

12. The vehicle pedal footwear protection device of claim 7, wherein the first top surface is comprised of a waterproof coating.

13. The vehicle pedal footwear protection device of claim 7, wherein the first top surface is comprised of a raised texture.

14. The vehicle pedal footwear protection device of claim 7, wherein the first top surface is comprised of a recessed texture.

15. A method of using a vehicle pedal footwear protection device, the method comprising the following steps:
providing a vehicle pedal footwear protection device comprised of a body comprised of a top surface and a bottom surface comprised of a fastener;
attaching the fastener to a vehicle floor; and
placing a foot of a user on the top surface while using a pedal of a vehicle.

16. The method of using a vehicle pedal footwear protection device of claim 15, wherein the fastener is attached in front of the pedal.

17. The method of using a vehicle pedal footwear protection device of claim 15, wherein the fastener is attached underneath the pedal.

18. The method of using a vehicle pedal footwear protection device of claim 15, wherein the top surface is comprised of a microfiber, a neoprene, a felt, a silicone, a leather, a faux leather, a polyurethane foam, a suede, a plastics, or a thermoplastic elastomers.

19. The method of using a vehicle pedal footwear protection device of claim 18, wherein the top surface is comprised of a waterproof coating.

20. The method of using a vehicle pedal footwear protection device of claim 15, wherein the fastener is comprised of a hook fastener, a loop fastener, an adhesive fastener, a clip fastener, or a magnet.
